(19) United States
(12) Patent Application Publication
(10) Pub. No.: US 2003/0014483 A1
(43) Pub. Date: Jan. 16, 2003

(54) Dynamic networked content distribution

(76) Inventors: Daniel C. Stevenson, Cambridge, MA (US); Brian Zotter, Saint James, NY (US); Stuart John Edmondston, Boston, MA (US); Edward Joseph Ferrara, Massapequa Park, NY (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/122,467

(22) Filed: Apr. 12, 2002

Related U.S. Application Data
(60) Provisional application No. 60/283,606, filed on Apr. 13, 2001.

(51) Int. Cl. G06F 15/16

(52) U.S. Cl. 709/203; 709/246

(57) ABSTRACT

A content exchange system and method of operation thereof for the dynamic acquisition, management and distribution of content through a network and to content clients. A content exchange system includes a content acquisition system communicating with a content source for receiving content from the content source and parsing and formatting the content for storage and for distribution to the content clients, a repository system for storing and managing the content and content relationships and for retrieving the content for distribution to the content clients, and a content distribution system for receiving the content from the repository system and formatting and distributing the content to the content clients.

### CROSS REFERENCES TO RELATED APPLICATIONS

This patent application is related to and claims benefit of priority from U.S. Provisional Patent Application Serial No. 60/283,606 filed on Apr. 13, 2001.

### FIELD OF THE INVENTION

The present invention is directed to a system and methods implemented therein for the dynamic distribution of content through networks and, in particular, to a system and methods implemented therein for the dynamic acquisition, management and distribution of content through a network.

### BACKGROUND OF THE INVENTION

The acquisition and distribution of information through private and public networks, and in particular through public networks such as the Internet, have become very common with virtually every business and school and a large proportion of private residences having access to and receiving and transiting information through the Internet. The variety and volume of information acquired and distributed through the Internet is extremely large and is increasing rapidly and includes business information and transactions, educational resources and various forms of entertainment. This information is often and generally referred to as “content” and, for purposes of the following discussions, includes essentially all types or forms of information or data that may be acquired or distributed through a network. Content may include any form of data that may be contained in any form of computer supported file, object or other body of data in any format, such as, and for example, a document, a spreadsheet, a database record, graphic or audio information, or a web page, such as a hypertext markup language (HTML) pages, and so on.

A recurring problem with the acquisition and distribution of content through a network such as the Internet, however, is in managing the acquisition and distribution of content as business requirements and network technologies evolve, often very rapidly, and the content and manner distribution of content must evolve or change as rapidly. For example, the goods or services offered by a business may change rapidly in the ordinary course of business, or a business may expand or change the type and nature of goods or services offered or the market to which the goods or services are offered. The content distributed in association with financial services, for example, is typically updated daily and even hourly or at shorter intervals, while other businesses typically update their distributed content weekly, monthly or on a seasonable basis. It must be noted that this problem is compounded in that the distribution of content typically also requires equal facility in the rapid acquisition of content. For example, many businesses and services on the Internet, such as financial services or business, must acquire and process financial information, such as stock prices and trends, business information, interest and exchange rates, at a rate that is as fast as or faster than the rate at which the content is distributed. Yet other businesses and services, including, for example, both business, news and entertainment enterprises, are essentially content distributors, or syndicators, whose entire efforts are centered around the timely acquisition and distribution of content.

The problems of content acquisition, management and distribution are compounded still further by the evolving demands, applications and technologies for content distribution. The range and variety of content distribution on the Internet are evolving and changing rapidly, as are new applications for content distribution, and each change or new application being new problems, demands or requirements in the acquisition, management and distribution of content. For example, recent developments in content distribution include the real time distribution of music, voice and video or graphic information in the entertainment industry. Yet other problems, demands and requirements in network content distribution arise from new distribution technologies, such as wireless networks distributing content through cell phones and wireless personal assistants.

To illustrate, previous systems and methods for the distribution of content on, for example, the Internet, have generally included both systems developed by a content distributor for the general distribution of content from a variety of clients or businesses and systems developed by individual businesses or services and tailored to their individual and specific needs. The general content distribution systems serving a variety of clients, however, have typically provided “vanilla” services using long established and accepted industry standard technologies and methods. That is, the clients are required to conform their content to a limited range of forms, presentations and types of services supported by the distributor system, and which have been selected according to a common denominator rather than according to the individual needs of desires of the clients. Not only are the clients limited in the range of content types, presentations and services that are available to them, but the clients have little effective control over their content in these respect, or even in such issues as security. In addition, the clients are typically required to provide all content updates or changes, which can often be a difficult, complex, burdensome and neglected task for many clients. Also, the providers of such distribution services are often slow or reluctant to adapt to new forms of content and new methods of content distribution, such as wireless networks, because of the cost and uncertainty of entering a new market or adopting a new and non-established technology.

Systems developed by an individual distributor to meet the individual and specific desires and needs of the distributor better meet the requirements for content type, presentation and services of the individual distributor, as well as providing greater control of these factors and such factors as security and control of content. Many such distributors, however, are limited in the expertise and resources to adequately implement such systems, to subsequently maintain such systems, including the updating and revision of content, and to adapt the systems to changing content, markets or network technologies. These problems are compounded yet further in that many such systems employ proprietary or nonstandard technologies and methods, which often further increases the costs and increases the difficulty in adapting to changing content, markets or network technologies.

The present invention addresses and provides a solution to these and other related problems of the prior art.

### SUMMARY OF THE INVENTION

The present invention is directed to a content exchange system and method of operation thereof for the dynamic acquisition, management and distribution of content through a network and to content clients.

A content exchange system includes a content acquisition system communicating with a content source for receiving content from the content source and parsing and formatting the content for storage and for distribution to the content clients, a repository system for storing and managing the content and content relationships and for retrieving the content for distribution to the content clients, and a content distribution system for receiving the content from the repository system and formatting and distributing the content to the content clients.

In a present embodiment of the content exchange system, a content acquisition system includes a retrieval engine for acquiring content from the content source, including one or more of actively fetching content from the content source and passively accepting content from the content source, and a content processor, which includes a content parser for parsing the content into content items wherein each content item is an identifiable body of content, a content formatter for formatting the content into formats and relationships identified by the content clients, and a tag mechanism for associating a tag with each content item wherein each tag contains identification information pertaining to the corresponding content item. The content processor and tag mechanism may further associate content items in accordance with aggregation relationships defined by identification information residing in the corresponding tags.

A retrieval engine may include a retrieval agent for communicating with a content source and acquiring content from the content source, including one or more of actively fetching content from the content source and passively accepting content from the content source, and a retrieval process defined by one or more content clients for controlling a corresponding retrieval agent.

The repository system will include a repository for storing the content, a repository manager for controlling the storage of data in the repository, at least one repository connector providing a defined access path to the repository, and a query engine for receiving requests for content from content clients and generating corresponding queries to the repository for the requested content, wherein the repository manager is responsive to a query for providing the requested content to the requesting content client. The repository system may also include a cache connected from the repository for storing and providing the content to content clients.

The repository will typically include at least one repository template associated with the at least one repository connector for formatting content to be stored in or read from the repository, and a data persistence manager associated with the repository manager for managing the duration of storage of content items in the repository.

The query engine may include a request parser for parsing and deconstructing requests to identify the content items and requirements of each request for content, and at least one query template for formulating a query corresponding to the content items and requirements identified from a content request.

The content distribution system may include one or more of a dynamic server optimized for the general distribution of content to content clients, and a syndication server for distribution of content to associated content clients. A content distribution system will also include a distribution mechanism for distribution of content to content clients, and a formatting mechanism for formatting content into formats defined by the content clients. A formatting mechanism will include a formatter for receiving content from the repository system and formatting the content for distribution to a content client, wherein the formatter will include a template engine for formatting content and at least one template for defining a format for content.

Other features, objects and advantages of the present invention will be understood by those of ordinary skill in the relevant arts after reading the following descriptions of a presently preferred embodiment of the present invention, and after examination of the drawings, wherein:

### DESCRIPTION OF THE DRAWINGS

FIGS. 1A and 1B are block diagrams of a repository system of the system of the present invention;

FIG. 2 is a block diagram of a content acquisition system of the system of the present invention;

FIG. 3 is a block diagram of a syndication server of the system of the present invention; and

FIG. 4 is a block diagram of content distribution mechanisms of the system of the present invention.

### DETAILED DESCRIPTION OF THE INVENTION

1. Introduction

The present invention provides a system, referred to herein as a “content exchange system”, for the network based acquisition, management and distribution of content. As will be described, a “content exchange system” includes mechanisms for the acquisition of a wide range of forms and types of content from a wide range of types of providers, either under direct control by the providers or a system administrator or automatically under control of acquisitions residing in the “content exchange system”. The providers may include, for example, other network sites, databases, syndicators, and networks of enterprises, Web sites, mail servers, databases, and other common sources, including legacy applications and Enterprise Application Integration (EAI) platforms. The acquired content is converted into a form or forms selected for management and manipulation by “content exchange system” and is stored in a repository for distribution to clients. The content management function of a “content exchange system” includes, for example, content update and acquisition functions and data persistence functions. Lastly, a “content exchange system” includes mechanisms for the distribution of content in a wide range of forms to a wide range of types of clients, including syndicated distribution, individual client distribution, and automatic and on request distribution, and channel mechanisms. The distribution mechanisms of a “content exchange system” further include mechanisms for the conversion of the content into a range of forms and formats, and the distribution, format and presentation of content are controllable by the Content Sources.

As will be described, a “content exchange system” may acquire, store and distribute, for example, transaction data from back-end systems, streaming data feeds, data warehouses, directory servers, and any other dynamic or static data source, as well as “document-style” content. For this reason, it will be understood that for purposes of the following discussions the term “content” includes essentially all types or forms of information or data that may be acquired or distributed through a network. In addition, and while a “content exchange system” includes a repository for storing content for distribution, a “content exchange system” may acquire content from, store content in and, distribute content to a range of types of repositories.

Also, the individual components of a “content exchange system” may be implemented in a variety of configurations to provide specific focused services or systems emphasizing specific aspects or functions of a “content exchange system”, such as content acquisition, content management, syndication, or distribution of content. The elements and components of a “content exchange system” may also be configured to comprise a variety of architectures, including as a distributed web content network wherein elements of a “content exchange system” are implemented across a number of systems or network sites and interconnected through a network, or as web networks to create large integrated systems. For example, certain network sites or servers may perform content acquisition functions, while others may perform the content repository and content distribution functions. In addition, the elements of a “content exchange system” may be implemented, for example, in a distributed fashion across desktops or mobile devices, or as a set of federated or syndicated services, or as a traditional client-server model or as a multi-tier or peer-to-peer model. For these reasons, the term “network”, in turn, refers to any form of network that may be used for the distribution of data or information and includes, for example, the Internet, while the term “content exchange system” will refer to any configuration of the elements of a “content exchange system”, either on a single system or implemented across several systems.

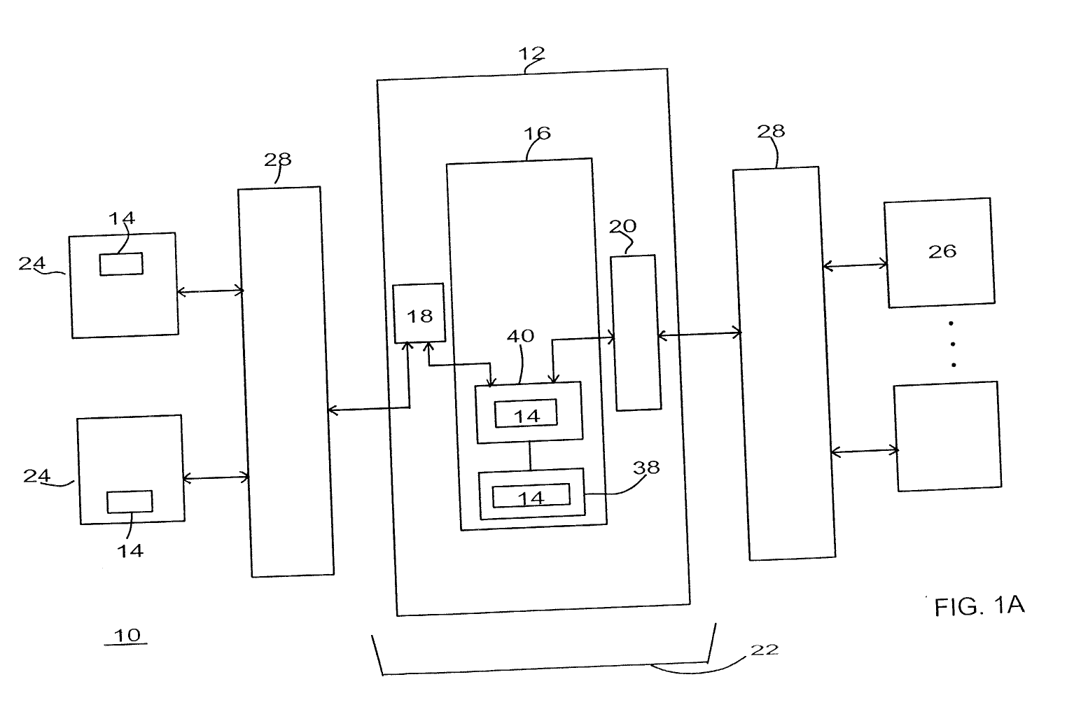

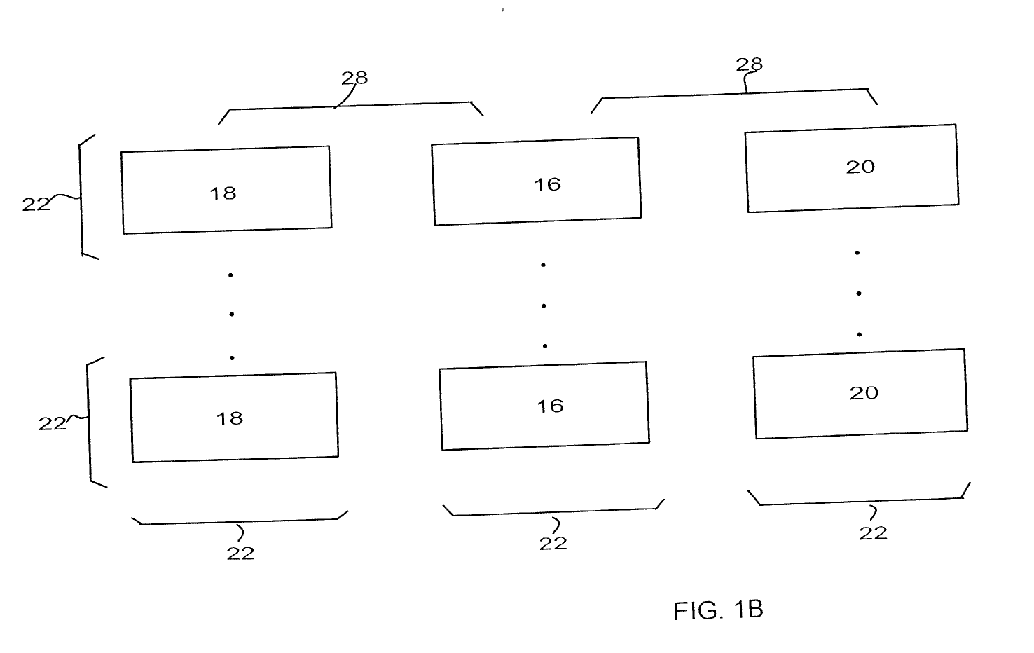

2. General Description of a Content Exchange System (FIGS. 1A and 1B)

Referring to FIG. 1A, there is illustrated an exemplary Content Web Network 10 including a Content Exchange System 12 for the acquisition, storing and distribution of Content 14. As shown therein a Content Exchange System 12 includes a Repository System 16, an Content Acquisition System 18 and a Content Distribution System 20 residing in a Network Site 22. The Content Exchange System 12, in turn, communicates with one or more Content Sources 24 and one or more Content Clients 26 through a Network 28 which may be comprised, for example, of the Internet, a Local Area Network (LAN), a Wide Area Network (WAN), a Wireless Network or a combination of such networks.

As will be described further in the following, a Repository System 16 further operates as the central hub of a Content Web Network 10 to both receive and store acquired Content 14 and to distribute acquired Content 10. The Repository System 16 further operates as a central hub for user, system administrator, Content Source 24 and Content Client 26 interactions with a Content Exchange System 12. For example, a user, system administrator or Content Client 26 may submit requests for searches or queries of the acquired Content 14 residing in Repository 38 and Cache 40, or of Content 14 residing in Content Sources 24, and the Repository System 16 mechanisms described above and in the following will respond to fulfill the request, passing the requested Content 14 to Content Distribution System 20 to be provided to the requester.

A Repository System 16 thereby receives Content 14 from Content Sources 24 through an Content Acquisition System 18, stores, secures and manages the Content 14 in a Repository 38, and provides the Content 14 from the Repository 38 to a Content Distribution System 20 for distribution to Content Client 26. Repository System 16 further includes content management access and mechanisms for Content Sources 24, provides alternate access paths between Content Sources 24 and Content Clients 26, and provides mechanisms for collaboration between and among applications accessing or using Contents 14.

An Content Acquisition System 18 typically includes retrieval agents for actively fetching or passively accepting Content 14 from Content Sources 24 in a range of forms and formats. An Content Acquisition System 18 further includes parsing and formatting processors for converting or transforming Content 14 from Content Sources 24 into a form or forms for storing in the Repository System 16, including tagging of Content 14 to identify, for example, the sources of or relationships between Content 14 items. An Content Acquisition System 18 also manages content aggregation relationships, including tagging, funneling and aggregating or combining of Content 14 according to desired or selected relationships, such as by type of Content 14, interests of Content Clients 26 or business relationships.

Lastly, a Content Distribution System 20 may include one or more distribution servers for Content 14 redistribution among partnered, syndicated or otherwise associated, related or cooperating Content Sources 24 and Content Clients 26 and for distribution of Content 14 to Content Clients 26. The Content Distribution System 20 distribution will typically include security mechanisms for controlling access to Content 14 by Content Clients 26, will support selective Content 14 queries and will control access to Content 14 by Content Clients 26. A Content Distribution System 20 may also include mechanisms for converting or formatting stored Content 14 into forms and formats suitable to or desired by various Content Clients 26, and will support the personalization of Content 14 to be distributed to corresponding Content Clients 26.

It will be understood that, as illustrated in FIG. 1B, the elements of a Content Exchange System 12, that is, one or more of each of a Repository System 16, an Content Acquisition System 18 and a Content Distribution System 20, may be distributed and implemented across and in a plurality of Network Sites 22. For example, the Repository System 16, an Content Acquisition System 18 and a Content Distribution System 20 may each reside in a different Network Site 22 and, in such instances, will communicate through, for example, a Network 28. It should also be understood that a Content Exchange System 12 may include, for example, a plurality of Content Acquisition Systems 18 or Content Distribution Systems 20 or any combination of Repository Systems 16, Content Acquisition Systems 18 or Content Distribution Systems 20, depending upon the specific functions or services to be provided by or supported by a Content Exchange System 12. It will also be understood that at least certain Content Sources 24 may also be Content Clients 26, and that certain Content Sources 24 or Content Clients 26 or combinations of Content Sources 24 or may comprise, for example, federations, syndications, networks or other combinations or organizations. The adaptation and implementation of a Content Exchange System 12 as, for example, a distributed system or as a configuration of multiple Repository Systems 16, Content Acquisition Systems 18 or Content Distribution Systems 20 or for various Networks 28 or combinations of Networks 28, will be well understood by those of ordinary skill in the arts after reading the following discussions, and will therefore not be discussed in detail herein.

Lastly with respect to the general principles of a Content Exchange System 12, and as described in the following with regard to preferred embodiments of the present invention, each functional element or group of related functional elements of a Content Exchange System 12, such as an Content Acquisition System 18, a Repository System 16 or Content Distribution System 20 or sub-mechanisms thereof, should preferably be essentially self-contained. In addition, there should be clean and direct, well defined interfaces between such functional units or sub-units and each functional unit, sub-element or sub-mechanism should be module and as simple and basic are necessary for a given specific operation. That is, the addition or modification of functionality, such as the retrieval of a different type of content, the parsing of a different type of content or an alternate system configuration to meet desired operational requirements, should be by the addition of further simple functional modules rather than by modification of or addition to a complex functional module.

In brief and in summary, therefore, it will be recognized from the above summary description of a Content Exchange System 12 and from the following detailed descriptions of the elements of a Content Exchange System 12 that a primary aspect of a Content Exchange System 12 is, in fact, the exchange of content. That is, and further in summary, a Content Exchange System 12 has four primary modes of operation: (a) the acquisition of content into a repository, (b) the distribution of content from a repository, (c) the acquisition of content into a repository and the subsequent distribution of content from the repository, and, (d) the acquisition and immediate distribution of content in a “straight-through” manner and without storage of the content in a repository. It will therefore be recognized that the acquisition, storage and distribution of content essentially different configurations and different aspects of content exchange and may be implemented in many ways and in many forms within the concepts and context of the present invention. For example, and by way of a specific illustration, the following discussions and descriptions frequently refer to and extensively describe a Repository System 38. While the following descriptions and discussions address and describe the structures and operations of a Repository System 38 with respect to Repository's 38R and the associated mechanisms and functions, it must be recognized that a primary aspect of a Repository System 38 is the structures and operations of a Repository System 38 for operating with content repositories, that is, the connectors and operations of a Repository System 38 for facilitating content storage and retrieval functions, rather than the structures and operations of a Repository System 38 as a repository in itself.

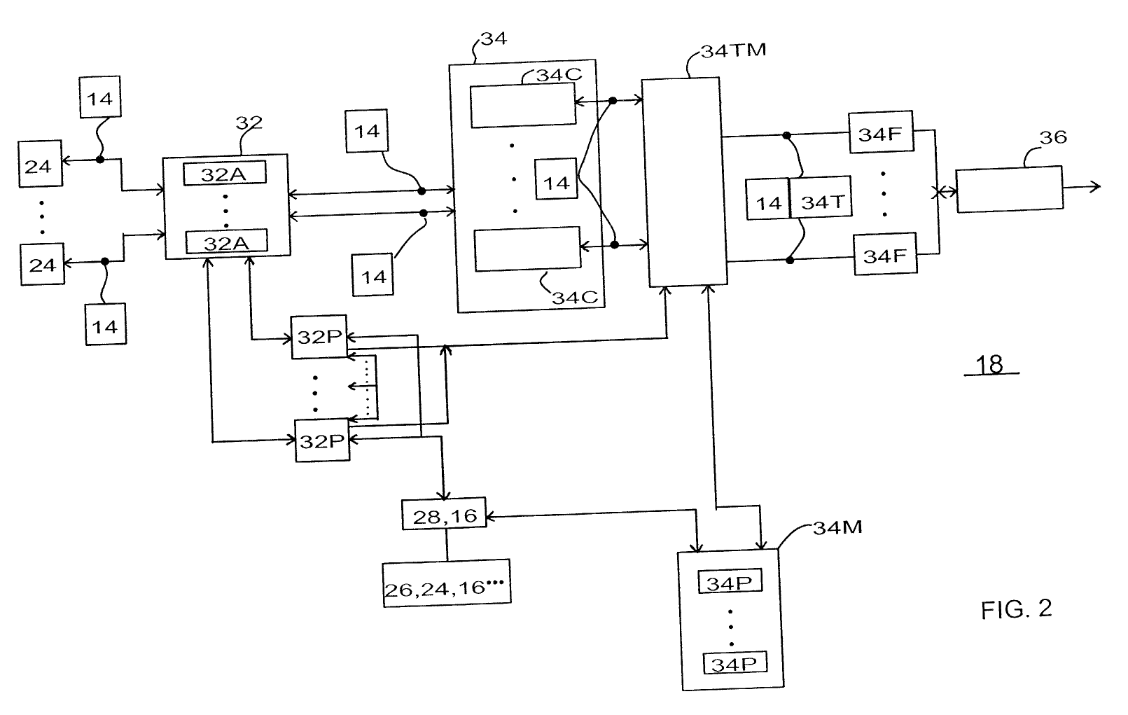

3. Detailed Descriptions of Elements of a Content Exchange System 12 (FIGS. 2, 3 and 4)

A. Content Acquisition System 18 (FIG. 2)

Referring to FIG. 2, therein is shown a block diagram of an exemplary Content Acquisition System 18. As described above, an Content Acquisition System 18 is a system for acquiring, deconstructing, normalizing, aggregating and tagging of Content 14 received directly or indirectly from any internal or external Content Source 24 in any form or format and through any communications/data transfer protocol. An Content Acquisition System 18 further operates to provide the acquired Content 14 to the Repository System 16 in the forms and formats preferred by the Repository System 16, and to establish and construct relationships or aggregations among bodies of Content 14 as desired by, for example, Content Clients 26 or Content Sources 24. In this regard, it must be noted that a Repository 38 can be, for example, a content management system or document management system (CMS/DMS). In the case of a CMS/DMS, the repository may include content acquired using many different content acquisition systems, and may be used to provide content for many different content distribution systems. Likewise, a content acquisition system may provide content to several different repositories, including different CMS/DMS, and a content distribution system may distribute content from many different repositories.

First considering the acquisition of Content 14 by an Content Acquisition System 18, Content Sources 24 may be external to the Content Acquisition System 18 or Content Exchange System 12 or internal to the Content Acquisition System 18 or Content Exchange System 12, as may be Content Clients 26. For purposes of the following discussions, an external Content Source 24 or Content Client 26 may include any Content Source 24 or Content Client 26 external to the Content Exchange System 12, such as a Content Source 24 communicating with the Content Acquisition System 18 through a Network 18 or connected directly to the Content Acquisition System 18. External Content Sources 24 may include, for example, other network sites, databases, syndicators, and networks of enterprises, Web sites, mail servers, databases, and other common sources, including legacy applications and EAI (Enterprise Application Integration) platforms. An Content Acquisition System 18 may also support links to remote databases for the acquisition of Content 14, such as JDBC- or ODBC-enabled databases, legacy systems, and other enterprise applications.

An internal Content Source 24 in turn may include, for example, a Content Source 24 having Content 14 already residing in the Repository System 16 repository. An internal Content Source 24 or Content Client 26 may also be a Content Source 24 or Content Client 26 residing within a system or enterprise in which the Content Exchange System 12 or Content Acquisition System 18 resides. When the desired Content 14 already resides in the Repository System 16 repository, the Content Acquisition System 18 will acquire the Content 14 from the Repository System 16 repository and, when the Content Source 24 resides in the same system or enterprise as the Content Acquisition System 18, the Content Acquisition System 18 will acquire the Content 14 in the same manner as for an external Content Source 24.

It must also be noted that an Content Acquisition System 18 may also be required to communicate with Content Sources 24 through a plurality of communications/data transfer protocols, such as HTTP, HTTPS, FTP, POP, and SMTP.

In summary, therefore, an Content Acquisition System 18 may be required to acquire Content 14 from a plurality of Content Sources 24, each of which may provide Content 14 with a different type or in a different format and each of which may provide the Content 14 through a different communications/data transfer protocol, or any combination thereof. As illustrated in FIG. 2, Content 14 is acquired through the operation of a Retrieval Engine 32 that will include one or more Retrieval Agents 32A for acquiring Content 14 from Content Sources 24. Each Retrieval Agent 32A will typically interoperate with a given type of Content Source 24, as defined by the type or format of Content 14 provided by the Content Source 24 and the communications/data transfer protocol employed between the Content Source 24 and Content Acquisition System 18. Retrieval Agents 32A may include, for example, Retrieval Agents 32A for fetching Web pages or Web page contents, email, serial data, including voice, audio and video content, and various forms of database content. Retrieval Agents 32A may also include, for example, Retrieval Agents 32A for syndicated Content 14 as well as custom Retrieval Agents 32A for non-standard or non-conventional forms of Content 14 or specialized or non-conventional Content Sources 24.

Content 14 retrieval may be automated or may be performed on an as-needed basis and Retrieval Agents 32A may be required to both actively fetch Content 14 from Content Sources 24 and to passively accept Content 14 from Content Sources 24. In the instance of active retrievals, a Retrieval Agent 32A will assume the initiative in acquiring Content 14 from a Content Source 24. For example, a Retrieval Agent 32A may query or search a Content Source 24 for new, changed or updated Content 14 or may issue a request for new, changed or updated Content 14. An active Retrieval Agent 32A may query a Content Source 24 at times or intervals, for example, specified by a Content Client 26 or the Content Source 24 or upon individual request by a Content Client 26. Certain Retrieval Agents 32A may also operate as or in conjunction with search engines so search Content Sources 24 based upon criteria selected by, for example, a Content Client 26. In the instance of passive acquisitions of Content 14, in contrast, the Retrieval Agents 32A will receive and accept Content 14 when provided to the Retrieval Agents 32A by the Content Sources 24.

As indicated in FIG. 2, the operations of Retrieval Agents 32A are controlled by Retrieval Processes 32P wherein each Retrieval Process 32P includes information, definitions and parameters defining one or more acquisitions of Content 14 to be executed by the Content Acquisition System 18. The information comprising a Retrieval Process 32P may include, for example, the source location and content format of the Content 14, a retrieval schedule, a per-source categorization, security parameters, content filters, and other parameters of the acquisition relationships, including communication and data transfer protocols, and other user-defined factors and parameters. As indicated in FIG. 2, Retrieval Processes 32P of the information comprising Retrieval Processes 32P may be provided, for example, from Content Clients 26, Content Sources 24, a Repository System 16 or as user inputs and may be provided directly to the Content Acquisition System 18 or through a Network 28 or from a Repository System 16. As also indicated, Retrieval Processes 32P may reside in or in association with the Retrieval Agents 32A that they control, in a distributed manner, or may reside in a centralized Retrieval Manager 32M which provides centralized coordination and management of Retrievel Agents 32A.

It will therefore be noted that the range or types of Content Sources 24 from which a Retrieval Engine 32 may acquire Content 14, that is, the types and formats of Content 14, the types of Contents Providers 24, the communications/data transfer protocols through which Content 14 is acquired, and the processes by which Content 14 is acquired, such as active, passive or on-demand, may be selected by appropriate and corresponding selection of Retrieval Agents 32A and Retrieval Processes 32P. It should also be noted that an Content Acquisition System 18 may support multiple simultaneous retrieval processes, and that a plurality of Content Acquisition Systems 18 may be implemented in parallel, in a single Network Site 22 or in several Network Sites 22, as necessary to support the desired acquisition processes. As will be discussed in the following with respect to a Repository System 16, a Repository System 16 will track and manage the storage of Content 14 to avoid multiple instances of a Content 14 or confusion between Contents 14.

As described, an Content Acquisition System 18 provides the acquired Content 14 to a Repository System 16 in forms and formats preferred by the Repository System 16, and establishes and constructs relationships or aggregations among bodies of Content 14 as desired by, for example, Content Clients 26 or Content Sources 24.

First considering the conversion of Content 14 acquired by Retrieval Agents 32A into forms or formats for storage in a Repository System 16, as represented in FIG. 2 an Content Acquisition System 18 includes an Acquired Content Processor 34, which typically includes a plurality of Content Parsers 34C. Each Content Parser 34C is comprised of a set of document or content services with domain expertise in a range of content forms and formats, including, for example, text, binary and graphics formats, structured text, XML and WML, HTML, e-books, database formats, popular EDI formats, PDF, and Microsoft Office and other desktop application data formats. Content Parsers 34C receive acquired Content 14 from Retrieval Agents 32A of Retrieval Engine 32 and validate and deconstruct each acquired body of Content 14 into its constituent Content 14 elements. As will be discussed further below, the parsing and deconstruction of each Content 14 allow individual elements of a given Content 14, such as individual fields of a Web page, to be identified and extracted from the Content 14. For example, the Content 14 provided by a Content Source 24 may be comprised of pages of stock quotations and the Content 14 elements identified and extracted by Content Parsers 34C may be comprised of one or more data fields of individual stock quotations. It will be apparent to those of ordinary skill in the relevant arts that the types, forms and formats of Content 14 that may be parsed and deconstructed by an Acquired Content Processor 34 may be readily adapted to desired selections of Content 14 types, forms and formats by the selection and implementation of appropriate Content Parsers 34C, and that the range of Content 14 types, forms and formats may be readily extended to new types, forms and formats of Content 14 by the provision of appropriate Content Parsers 34C.

As shown in FIG. 2, the parsed Content 14 elements are provided by Content Parsers 34C to one or more Content Formatters 34F, which convert or transform and normalize the parsed Content 14 elements into forms or formats appropriate for storage by the Repository System 16. As will be described in further detail in a following description of a Repository System 16, a Repository System 16 will store the acquired Content 14 in one or more content repositories wherein each content repository is comprised, for example, of a database. The conversion, transformation and normalization of various forms or formats of Content 14 and Content 14 elements into forms and formats for storage in, for example, various forms and implementations of databases, are well known and understood by those of ordinary skill in the relevant arts and as such need not be discussed further herein.

It is often necessary or desirable to aggregate, combine, link or otherwise associate or establish a relationship, hereafter referred to as an “aggregation”, between Contents 14 and Content 14 elements acquired from one or more Content Sources 24. Such aggregation may be used, for example, to identify and extract specified information from Content 14, to combine information extracted from Content 14 in desired manners and arrangements, or to route or funnel Content 14 or information extracted from Content 14 to, for example, selected Content Clients 26 or into selected databases or information relationships and associations. Other aggregations may be based upon, for example, business relationships among Content Sources 24 and Content Clients 26, as in syndication relationships. In this regard, it must be noted that the term “syndication” is a term or art in the media and entertainment industries, and is more generally described by the term “content distribution”. Thus, while the term “syndication” will be used in its industry specific form herein, it will be understood to embrace the more general term “content distribution”. The “aggregation” of Content 14 or Content 14 elements thereby includes both associations with other Content 14 or Content 14 elements as well as with respect to selected criteria, such as content type, format, form, source and client relationships, subject matter, and so on.

It will therefore be apparent that aggregations may be based upon a variety of selectable criteria, such as a relationship between Content Sources 24 and Content Clients 26, or may be based in aspects or characteristics of the Content 14 or Content 14 elements, such as content source or type, content subject matter, identifiers internal to the Content 14 or Content 14 elements, and so on. For example, certain acquired Content 14 or Content 14 elements may be richly structured with associated, linked or otherwise related or linked Content 14 or Content 14 elements, such as a Web page with links to related pages, and it may be desirable or necessary to include or refer to such associated Content 14. Other aggregation relationships may arise from the manner in which or the reason for which the Content 14 is acquired, such as the results of search processes or syndicated Content 14. Other Content 14 or Content 14 elements, however, such as Content 14 acquired from a remote Network Site 22 as HTML files, may lack useful classification or organizational information to aid in establishing aggregations with other Content 14 or with selected criteria, although such aggregations may be necessary or desirable.

The aggregation of Contents 14 or Content 14 elements is implemented by the association of Tags 34T with the Contents 14 or Content 14 elements parsed, identified and deconstructed by Content Parsers 34C in any of a number of conventional methods. Each Tag 34T is comprised, for example, of identifying information, such as source, content type, form or format, content client, subject matter, and so on, or links or pointers to, for example, related Content 14 or Content 14 elements or Content Clients 26. Tags 34T are generated and associated with the Contents 14 or Content 14 elements by a Tag Mechanism 34TM which interoperates with Content Parsers 34C and receives tagging information from Content Parsers 34C, such as information extracted from or derived from the Contents 14 parsed and deconstructed by the Content Parsers 34C. Tag Mechanism 34TM may also receive tagging information from Parse/Tag Processes 34P residing in Parse/Tag Manager 34M, which is discussed further below and which controls the operations of Content Parsers 34C and Tag Mechanism 34TM through Parse/Tag Processes 34P. Tag Mechanism 34TM may also receive information relating to tagging operations from Retrieval Processes 32P.

In this regard, it should be noted that the tagging information provided to Tag Mechanism 34TM from Retrieval Processes 32P may be provided either directly or indirectly, depending upon the implementation of a Content Exchange System 12. For example, Retrieval Process 32P information related to or useful in tagging operations may be associated directly with the acquired Content 14 provided to Acquired Content Processor 34, that is, effectively as part of the acquired Content 14, thereby allowing a distributed architecture between Retrieval Engine 32 and Retrieval Agents 32A and Acquired Content Parser 34 and Content Parsers 32C. In other implementations, an identification of the Retrieval Process 32P controlling the acquisition of a Content 14 may be associated with the acquired Content 14 that is provided to the Acquired Content Processor 34 and Tag Mechanism 34TM may use the Retrieval Process 32P identification to access the corresponding Retrieval Process 32P and read the necessary information, thereby implementing a more centralized architecture for Acquired Content Parser 32 and Content Acquisition System 28.

Lastly in this regard, it should be noted that tagging operations, that is, Parse/Tag Processes 32P may themselves be linked or chained to allow the defining and execution of more complex parsing and tagging operations. For example, the results of parsing and tagging operations performed under direction of a Parse/Tag Process 32P may be used as information into a subsequent Parse/Tag Process 32P. These capabilities allow, for example, acquired Content 14 or Content 14 elements may be searched for, identified, extracted, combined in desired ways and funneled to selected Content Clients 26. An example of such may be the automatic retrieval of stock quotation reports or text tables, the extraction of desired stock information, the combination of the desired information into specified report formats, and the funneling or providing of the final information to selected Content Clients 26.

As illustrated in FIG. 2, the operations of Acquired Content Processor 34, including Content Parsers 34C, Content Formatters 34F and Tag Mechanism 34TM, are controlled by Parse/Tag Processes 34P residing in Parse/Tag Manager 34M. As in the instance of Retrieval Processes 32P residing in Retrieval Manager 32M, each Parse/Tag Process 34P includes information, definitions and parameters defining one or more parsing, formatting or tagging operations or combinations or sequences thereof to be performed by Content Parsers 34C, Content Formatters 34F and Tag Mechanism 34TM. As described, these operations convert, transform and normalize Content 14 and Content 14 elements into the forms and formats preferred by the Repository System 16 and aggregate Content 14 or Content 14 elements. The information comprising a Parse/Tag Process 34P may include, for example, source location or client, content type, form and format, subject matter, and other parameters of the parsing and formatting operations and the aggregation of Content 14 of Content 14 elements. As indicated in FIG. 2, the Parse/Tag Processes 34P or the information comprising Retrieval Processes 32P may be provided, for example, from Content Clients 26, Content Sources 24, a Repository System 16 or as user inputs and may be provided directly to the Content Acquisition System 18 or through a Network 28 or from a Repository System 16. As also described above, Retrieval Process 32P information related to or useful in parsing, formatting and tagging operations may be associated directly with the acquired Content 14 provided to Acquired Content Processor 34, that is, effectively as part of the acquired Content 14. In other implementations, an identification of the Retrieval Process 32P controlling the acquisition of a Content 14 may be associated with the acquired Content 14 provided to the Acquired Content Processor 34 and may use the Retrieval Process 32P identification to access the corresponding Retrieval Process 32P and read the necessary information.

Lastly with respect to an Content Acquisition System 18, it is indicated in FIG. 2 that the acquired, formatted and normalized and aggregated Content 14 or Content 14 elements resulting from the operations of an Content Acquisition System 18 are routed to a Repository System 16 through an Input Queue 36, which may be implemented any of a variety of forms and structure well known to those of ordinary skill in the relevant arts. It has also been described that a Content Exchange System 12 may include plurality of Content Acquisition Systems 18 that may be implemented in parallel, in a single Network Site 22 or in several Network Sites 22, as necessary to support the desired acquisition processes. It will be recognized, therefore, that Input Queue 36 may comprise a direct connection between one or more Content Acquisition Systems 18 and a Repository System 16, or in one or more indirect connections, as through a Network 28, or any combination thereof. It should also be recognized that in certain implementations of a Content Exchange System 12 it may be desirable to implement the Acquired Content Processor 34 in association with the Repository System 16, that is, as part of the Repository System 16 or in a Network Site 22 in which the Repository System 16 resides, rather than in association with the Retrieval Engine 32 or Retrieval Engines 32. In such instances, or if the rate or volume of acquisition of Content 14 by the Retrieval Engine 32 is sufficiently high, a buffer or an Input Queue 36 may be implemented between Retrieval Engine 32 and Acquired Content Processor 34.

The specific implementation of Retrieval Engine 32 and Acquired Content Processor 34 will also influence the manner in which Retrieval Process 32P information is provided to Acquired Content Processor 34, if such information is provided to Acquired Content Processor 34. For example, it may be preferable to encapsulate Retrieval Process 32P information with the acquired Content 14 rather than requiring Acquired Content Processor 34 to fetch the information as required. In this regard, it should be noted that according to the principles of the present invention, each functional element of a group of related functional elements, such as Retrieval Engine 32 of Acquired Content Processor 34, should preferably be essentially self-contained and that there should be clean and direct well defined interfaces between such functional elements. Also, it is a principle of the present invention that each functional sub-element or sub-mechanism, such as Retrieval Agents 32A or Content Parsers 34C, should be as simple and basic are necessary for a given specific operation. That is, the addition or modification of functionality, such as the retrieval of a different type of content or the parsing of a different type of content, should be by the addition of further simple functional modules rather than by modification or addition to a more complex functional module.

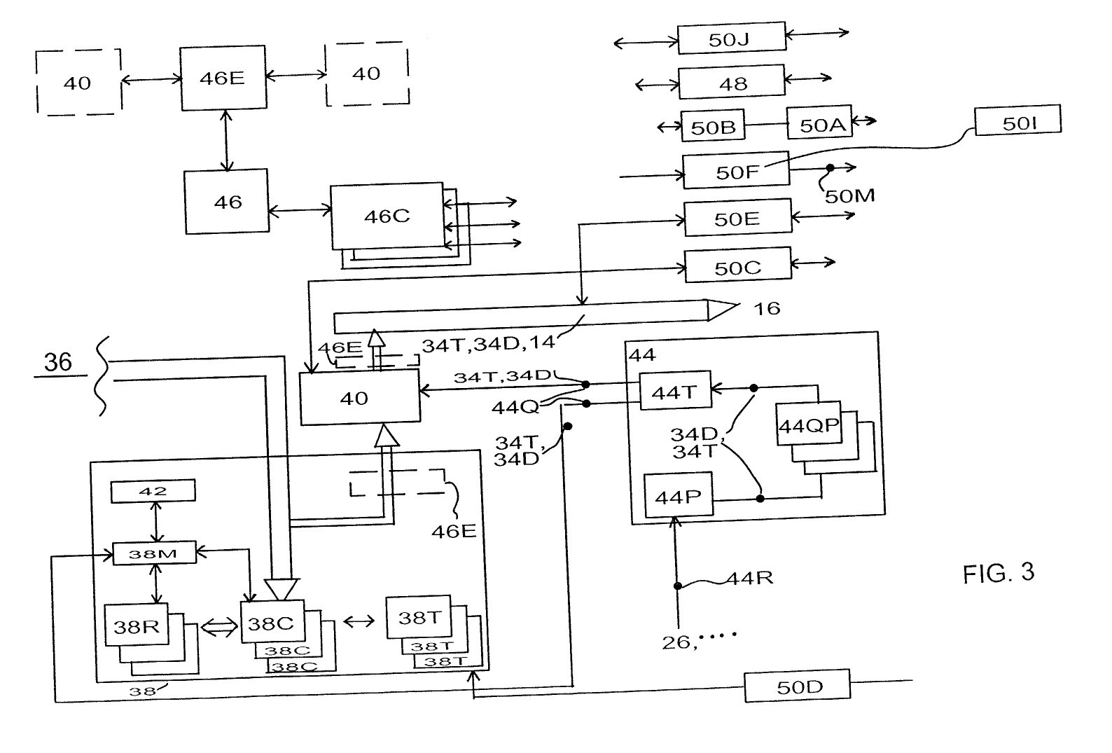

B. Repository System 16 (FIG. 3)

As illustrated in FIG. 1, Repository System 16 comprises a central hub for all Content 14 interactions, including both the acquisition of Content 14 from Content Sources 24 through one or more Content Acquisition Systems 18, the storing and management of Content 14 and the distribution of Content 14 to Content Clients 26 through one or more Content Distribution Systems 20. As will be described further in the following, Repository System 16 abstracts all interaction with Content 14 and Content 14 repositories, including storage and persistence, retrieval, and searching and provides services to content applications, including repository management, data persistence, multi-level caching, query translation, and integration with content management systems.

1. Repository 38

Referring to FIG. 3, Content 14 is received by Repository System 16 from one or more Content Acquisition Systems 18 through an Input Queue 36 and is stored in a Content Repository 38. As represented in FIG. 3, Repository 38 is comprised of one or more Repositories 38R, each of which may be, for example, a relational database such as Oracle, IBM, Microsoft, or Sybase databases, or other forms of data storage systems, such as file storage systems, including XML repositories, or object databases. Repositories 38R may also include non-traditional “repositories”, such as document and data workflow engines, off-line publishing applications, remote workforce management systems, proprietary data indices, such as Web site caches, and desk-top applications.

As shown, Repository 38 includes a Repository Manager 38M for administering and managing Repository 38 functions and operations and a Repository Connector 38C for and corresponding to each Repository 38R or type of Repository 38R. Each Repository Connector 38C includes the mechanisms and processes necessary for Repository System 16 or a user of the Content Exchange System 12 to communicate and interoperate with the corresponding Repository 38R or type of Repository 38R. For example, it should be noted that Repositories 38R may be resident with Repository System 16 or may be remote from Repository System 16 and that the associated Repository Connectors 38C may include mechanisms for communicating with remote Repositories 38R through, for example, a Network 28.

Repository System 16 and users of the Content Exchange System 12 may communicate with Repositories 38R through Repository Connectors 38C to perform typical repository operations, such as data retrieval and storage, searches, queries, data association, file and database sharing, data management operations and other common repository operations, including library services and other traditional content repository functions. As also indicated in FIG. 3, one or more sets of Repository Templates 38T may be associated with Repository Connectors 38C for use, for example, in forming, formulating and formatting Contents 14 or Repository System 16 or user interface inputs and outputs in the execution of Repository 38 operations. For example, Connectors 38C may use Repository Templates 38T in translating queries from a general representation specified in an application, remote interface call, or a page template into a form for a specific Repository 38R, whether the Repository 38R is, for example, a file system, database, search engine, content management system, or any other entity. Typical queries include data retrieval and storage, searches, and other common repository operations, including, for example, sharing of file systems or databases. Repository Templates 38T may also be used in transforming or formatting Content 14 to be written to a Repository 38R or Content 14 being read from a Repository 38R to the Repository System 16, a user or another Repository 38R.

Also associated with Repository 38 is a Data Persistence Manager 42 for performing typical Repository 38R data management functions as monitoring the lifespan of data and discarding outdated data, monitoring and correcting errors in Repository 38R data, and so on. Data Persistence Manager 42 will typically perform such functions under the direction of parameters provided, for example, by a Content Exchange System 12 system administrator or by a user, who may provide parameters for managing Content 14 belonging to or of interest to that user. In this regard, it should be noted that certain Content 14 may be shared or of interest in common among a plurality of Content Clients 26 and that Data Persistence Manager 42 parameters may be personalized to each Content Client 26, as discussed further below. In such instances, and for example, the Data Persistence Manager 42 parameters specific or personal to a given Content Client 26 may control, for example, the availability and presentation of Content 14 to the Content Client 26 rather than the actual lifespan or existence of the Content 14 in Repository 38. The design and operation of such Data Persistence Managers 42 are well known and understood by those or ordinary skill in the relevant arts, being a common database function, and as such will not be discussed further herein.

2. Cache 40

A Repository System 16 further includes a multi-level, distributed Cache 40 for buffering Content 14 access and storage. For example, and in addition to conventional cache operations, Cache 40 may store and retrieve skeleton information about a document, a data set, often referred to as metadata, or any other form or body of Content 14, which can be stored and managed independently from the full document, data set of body of Content 14. In a like manner, query results or result sets can be cached in both full and abbreviated modes or, as described, further below, the operations of Cache 40 may be personalized to individual Content Clients 26. Cache 40 may be shared among multiple application instances on a single Network Site 22 or across multiple systems or Network Sites 22. Cache 40 may also include Content Client 26 resident or Content Client 26 specific caches, that is, effectively as sub-caches of Cache 40, on, for example, on desktop computers or mobile devices. Such sub-caches of Cache 40 may be fully connected to the Repository System 16 and may provide, for example, special local services for data persistence and off-line activity. Cache 40 or sub-caches thereof may also operate independently from Repository 38 or in parallel with Repository 38 to pass Content 14 directly from a Content Source 24 to a Content 26 to support, for example, “straight through” processing in “real-time” transactions. As is conventional, Cache 40 will typically maintain a cache operations history to assure the successful completion of cache operations and transactions. In a presently preferred embodiment of Repository System 16, Cache 40 is implemented as a linked list of objects, but may be implemented in a range of other forms well known to those of ordinary skill in the arts, such as a dedicated object database server or as a hybrid cache spanning memory, database, and disk storage.

The content cache is also used to create snapshots of the content repository(ies) for the content distribution system. This is useful in the event that a repository is of a temporary nature or has a tenuous connection; if a repository is of a limited size and thus deletes content over time that may still be necessary for distribution; and if several repositories are used in combination for content distribution, so the cache maintains a composite snapshot of their content for use specifically for distribution. A snapshot may also be referred to as a content “package”.

3. Query Engine 44

As described, Repository System 16 further operates as the central hub of a Content Web Network 10 to both receive and store acquired Content 14 and to distribute acquired Content 10. The Repository System 16 further operates as a central hub for user, system administrator, Content Source 24 and Content Client 26 interactions with a Content Exchange System 12. For example, a user, system administrator or Content Client 26 may submit requests for searches or queries of the acquired Content 14 residing in Repository 38 and Cache 40, or of Content 14 residing in Content Sources 24 and the Repository System 16 mechanisms described above and in the following will respond to fulfill the request, passing the requested Content 14 to Content Distribution System 20 to be provided to the requester.

The structure and operations of a Repository System 16 include a number of mechanisms for extracting Content 14 from Repository 38 and Cache 40 for delivery to Content Clients 26, certain of which will be described in following discussions of a Repository System 16. For example, personalization connectors, discussed below, permit the as-needed or programmed and scheduled query and extraction of selected or identified Content 14 from Repository 38 or Cache 40 and the delivery of the Content 14 to a Content Client 26. Other interfaces and connectors, likewise discussed below, also support the extraction of Content 14 from Repository 38 or Cache 40 by or for a Content Client 26 and the delivery of the Content 14 to a Content Client 26.

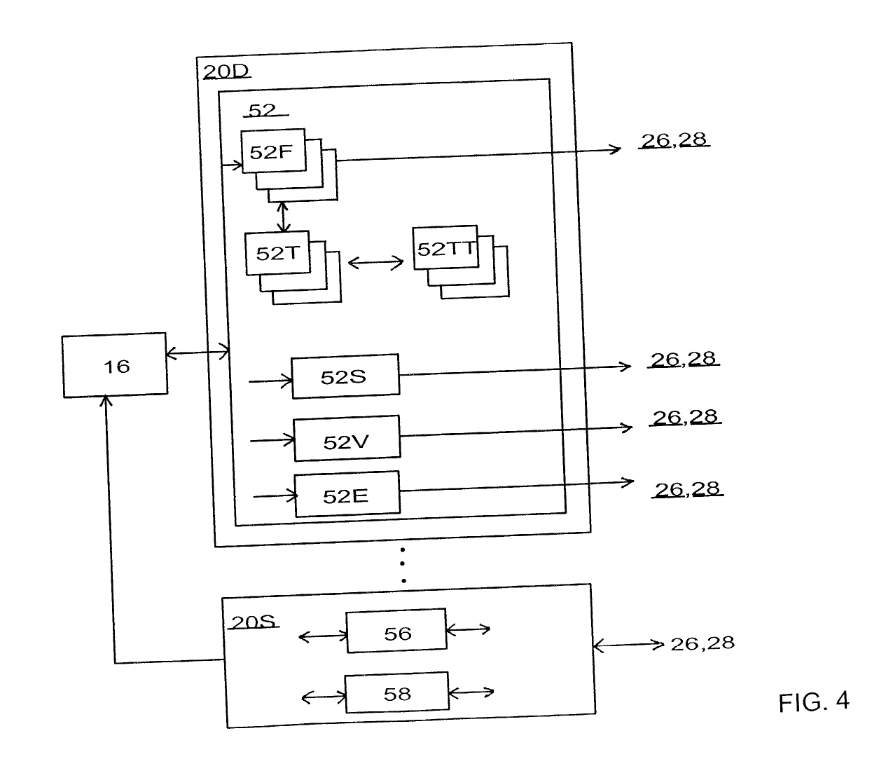

As represented in FIG. 4, the query, extraction and delivery of Content 14 are supported by a Query Engine 44 resident in a Repository System 16 and which includes mechanisms and processes for generating Queries 44Q to, for example, Repository Manager 38M and Cache 40, wherein Queries 44Q containing information directing the search, identification and extraction of Content 14 or elements of Content 14 from Repository 38 or Cache 40. Repository 38 and Cache 40 respond to each Query 44Q by providing the requested Content 14 or Content 14 elements to Content Distribution System 20 for delivery to the Content Clients 26.

Queries into repositories for content (specifically for distribution) may also be referred to as “channels” or “offers”, which may combine queries across different repository types, and which may be combined in turn to form “offer bundles”.

Query Engine 44 supports the selective query and extraction of Content 14 or Content 14 elements in response to requests from Content Clients 26, users or system administrators by translating Content Client 26 requests into corresponding Queries 44 to, for example, Repository Manager 38M or Cache 40. For these purposes, Query Engine 44 includes a Request Parser 44P for parsing and deconstructing Requests 44R from Content Clients 26, users, system administrators or personalization connectors, which are discussed below, to identify the elements, parameters and requirements of each request. Query Engine 44 further includes a library of Query Templates 44T for forming the query information extracted from each Request 44R into one or more corresponding Queries 44Q to Repository Manager 38M or Cache 40.

In this regard, it has been described that Content 14 acquired through the Content Acquisition System 18 is parsed, deconstructed, identified and tagged with Tags 34T before being stored in the Repository 38. As described, each Tag 34T is comprised, for example, of identifying information, such as source, content type, form or format, content client, subject matter, and so on, or links or pointers to, for example, related Content 14 or Content 14 elements or Content Clients 26. Tags 34T thereby provide information and a structure by which Query Engine 44 may identify in a Query 44Q the Content 14 or Content 14 elements to be provided by Repository 38 or Cache 40.

The above described Repository System 16 functions and mechanisms respond to a Query 44Q by identifying the requested Content 14 or Content 14 elements through Tags 34T and extracting the requested Content 14 or Content 14 elements. The Repository System 16 forms the requested Content 14 or Content 14 elements into the relationships, associations or aggregations identified in the corresponding Request 44R, and provides the requested Content 14 or Content 14 elements to Content Distribution System 20 with a corresponding distribution Tag 34D or distributions Tags 34D. In this instance, the associated Tag 34D or Tags 34D identify, for example, the Request 44R, the requester or requesting process, the requested form and format for the Content 14 and other parameters necessary for Content Distribution System 20 to form and format the requested Content 14 or Content 14 elements as required by the requester.

In this regard, it should be noted that a Content Client 26, a user, a system administrator or a personalization connector may submit a Request 44R for Content 14 or Content 14 elements on either an as-needed basis or as a programmed or scheduled extraction and delivery of Content 14, and that a Request 44R may be submitted either directly through Query Engine 44 or through another path, such as a personalization connector as described below. In either instance, Query Engine 44 will generate a corresponding Query Process 44QP which will control the generation of a corresponding Query 44Q, using the information parsed and deconstructed from the Request 44R and will generate the necessary distribution Tags 34D and associated Tags 34D with the Content 14 of Content 14 elements required by the Request 44R. In the case of an as-needed Request 44R, the corresponding Query Process 44QP will exist for the period required to complete the Request 44R. Query Processes 44QP generated for a programmed or scheduled extraction and delivery of Content 14, however, may exist for the period defined by the programmed or scheduled Request 44R and will be executed as directed by the programmed or scheduled Request 44R. Query Processes 44QP generated for a programmed or scheduled extraction and delivery may be stored, for example, in Query Engine 44, the originating personalization connector, or in Repository Manager 38M. In other instances, and for example, a scheduled or programmed Request 44R may be generated by means of a scheduled query program resident with the Content Client 26 or by means of a scheduled query program stored in, for example, Repository Manager 38M. In some instances, a corresponding Query Process 44QP will be generated for each occurrence of the programmed or scheduled Request 44R and will exist for the period required to complete the occurrence of the Request 44R.

4. Security Manager 46

Security requirements and operations are supported within a Repository System 16 through a Security Manager 46, which controls access and manages security for all Content 14 operations and applications, and specifically those pertaining to Repository 38 and Cache 40. For example, Security Manager 46 supports security frameworks and directory servers, including LDAP and other protocols and controls Content 14 access at several levels of user and data granularity, down to individual document elements and specific users, and up to entire document sets, including query result sets and user groups. As also indicated in FIG. 3, Repository System 16 may further include Encryption/Decryption Mechanisms 46E controlled by Security Manager 46 for encryption and decryption of Content 14, such as before, during, and after passage of Content 14 through Cache 40. Repository System 16 further includes one or more Security Connectors 46C may be associated with Security Manager 46 to integrate the security operations of Repository System 16 with other internal and external security applications using, for example, both proprietary and open standards. As described above with regard to Repository Connectors 38C, each Security Connector 46C includes the mechanisms and processes necessary for Repository System 16 or a user of the Content Exchange System 12 to communicate and interoperate with Security Manager 46 and the security functions, including Encryption/Decryption Mechanisms 46E.

Security Manager 46 also manages access to content exchange “Tasks”, such as a content acquisition process or a content distribution process, or parts therein.

5. Data Access Interface 48

Lastly with regard to the basic mechanisms of a Repository System 16, a Repository System 16 will include a Data Access Interface 48 interfacing with the functions and mechanisms of a Content Distribution System 20, which will be discussed further below. Data Access Interface 48 includes the functions, mechanisms and paths necessary for the retrieval of Content 14 from Repository 38 and Cache 40 by the Content Distribution System 20, and includes paths and connections for, for example, security functions and other user or Content Client 26 accessible functions and operations supported by the Repository System 16, as described next below. As the structure and operations of a Data Access Interface 48 will be well understood by those or ordinary skill in the relevant arts, and will be defined by the following discussions of additionally supported Repository System 16 functions and Content Distribution System 20 functions, Data Access Interface 48 will not be discussed further herein.

In addition to the above elements and mechanisms, a Repository System 16 includes a number of mechanisms, connectors, consoles and interfaces for managing repositories and repository connections, the cache, security, and other features. For example, a Repository System 16 include a Security Console 50A interfacing with Access Control APIs 50B and third-party security applications to manage security profiles and control access to specific items of Content 14. A Cache Interface 50C provides a user and system administrator interface for Cache 40 management, including altering Cache 40 parameters, viewing the active contents of Cache 40, flagging cached data for expiration or continued persistence, and administering multiple instances of a Cache 40.

6. Repository Explorer Interface 50D

A Repository Explorer Interface 50D allows administrators to manage and edit Content 14 stored in Content Repositories 38R managed by the Repository System 16. Repository Explorer Interface 50D allows users or a system administrator to edit individual elements of Content 14, perform queries, test personalization rule matches, described below, sort Content 14, export metadata and full document data to desktops, search across all Content Repositories 38R, modify the data storage schema, and otherwise manage Content Repositories 38R. It should be noted that a Repository Explorer Interface 50D is pertinent to and functionally concerned with the acquisition/distribution of content, rather than being just a general explorer functionality, and may, for example, be used specifically for evaluating, managing, configuring, and otherwise interacting with the processes and content used for content acquisition and distribution”.

7. Personalization Connectors 50E

A Repository System 16 may include one or more Personalization Connectors 50E to provide dynamic personalization of Content 14 from one or more Content Repositories 38C or Cache 40. In this regard, personalization must be regarded as having specific uses for the acquisition and distribution of content, such as personalizing queries into vast content repositories to extract only the relevant/desired content. In the instance of content distribution, personalization is useful for determining what content to send to recipients on a case by case basis.

As described, a connector includes mechanisms, protocols and processes for interfacing an exterior process, such as a user's application program, with interior resources of a Content Exchange System 12, and in particular with those of Repository System 16, to enable the exterior process access to the interior resources. In this instance, Personalization Connectors 50E may include, for example, adapters for rules engines, such as BEA WebLogic Personalization Server, ILOG and ATG Dynamo, Repository 38 connectors and query mechanisms. Personalization Connectors 50E may also HTML-style tags to reference the combined personalization functionality, and may support personalized programmed or scheduled extraction and delivery of Content 14 to Content Clients 26.

8. Event Mechanism 50F

A Repository System 16 may also include an Event Mechanism 50F to alert and activate external applications, such as user applications, to operations, processes, changes of state, inputs and so on, generally referred to as “events”, occurring in Repository System 16. As illustrated in FIG. 3, Event Mechanism 50F may include a configurable set of Event Filters 50G to detect selected “events”, such as “events” pertaining to Content 14, and to generate corresponding Event Messages 50H. Event Mechanism 50F will further include a configurable set of Message Queues 501 to broadcast and transmit Event Messages 50H representing filtered Content 14 “events” to external processes, such as electronic business applications. Messages Queues 501 may be implemented, for example, as JMS queues or in other point-to-point or publish-and-subscribe queue technologies, and by connection to, for example, EAI and B2Bi frameworks using proprietary and open standards. Event Messages 50H may be sent to passive or active servers running HTTP or other protocols, for example, to communicate with other applications. A Content Client 26 or other user may thereby, for example, monitor Content 14 flow for financial analysis, identify specific user events, and directly link Content 14 processes with other applications. The event mechanism is useful for creating higher-level acquisition/distribution processes that tie in other applications or systems with this system, such as external content processors, external schedulers, or external user applications.

9. Interfaces/Connectors 50J

Repository System 16 may further include one or more Interfaces/Connectors 50J providing direct access to Content 14 stored in Cache 40 and Repository 38 by, for example, user applications or systems such as desktop authoring and workflow applications and tools, and. In other instances, one or more Interfaces/Connectors 50J may provide an interface between a user, Content Client 26 or system administrator and other internal mechanisms of a Repository System 16, such as Query Engine 44, Repository Explorer Interface 50D or Personalization Connectors 50E. As described above, an interface or connector such as Interfaces/Connectors 50J is comprised of mechanisms, protocols and processes for interfacing an exterior process, such as a user's application program, with interior resources of a Content Exchange System 12, and in particular with those of Repository System 16, to enable the exterior process access to the interior resources.

Interfaces/Connectors 50J may, for example, support integration between the operations of Repository System 16 and e-commerce and personalization applications, such as J2EE-based products from BEA and ATG, and may include special adapters and connectors, application server internal connections, Java method calls, and HTML-style tag integration. Interfaces/Connectors 50J may also provide paths and methods for integration and communication between Content 14 and external or internal commerce, and community applications as implemented, for example, as partner and internal enterprise applications. Interfaces/Connectors 50J may provide interfaces and protocols for all elements and functions of a Content Exchange System 12, including secured access to the Cache 40 and Content Repositories 38C and underlying Content 14 parsing and formatting functionality. Interface/Connector 50J protocols may include, for example, XML-RPC, SOAP, UDDI, WSDL, and any convertible XML format transmitted over HTTP and other common protocols, such as Extensible Markup language Format (XML). Interfaces/Connectors 50J may also include remote Java interfaces and provide for distributed interactions at a very low level, allowing users to deploy broadly based applications that call on functionality in a back-end transactional application hand-in-hand with a content integration system, as if part of the same application. Interfaces/Connectors 50J may also provide a workflow interface to connect multiple applications into one cohesive system, including workflow integration systems such as BEA's WebLogic Process Integrator and workflow communication standards, including WFML.

C. Content Distribution System 20 (FIG. 4)

A Content Exchange System 12 has been described as a system for creating and managing relationships for acquiring and redistributing content in any format and through any protocol necessary or desired by a Content Source 24 or Content Client 26. As will be described, Content Distribution System 20 comprises a system for receiving Content 14 from Repository 38 or Cache 40 of a Repository System 16 and formatting Content 14 for delivery and display to Content Clients 26, including, for example, Content Clients 26 communicating or receiving Content 14 through Web, wireless, e-mail and other devices and methods and including syndicated Content Clients 26. As illustrated in FIG. 4, a Content Distribution System 20 will include one or more of either or both of Syndication Servers 20S or Dynamic Content Delivery Systems 20D. Content Distribution System 20 therefore comprises a templating and content delivery engine and mechanisms providing access to Repository System 16's Content Repositories 38R and Cache 40 and automatic Content 14 formatting for specific end-user devices or needs.

As will be described in the following, Dynamic Content Delivery Systems 20D are optimized for the general distribution of Content 14 to Content Clients 26 while Syndication Servers 20S are optimized for Content 14 redistribution among partnered, syndicated or otherwise associated, related or cooperating Content Sources 24 and Content Clients 26. Syndication Servers 20S or Dynamic Content Delivery Systems 20D may also include mechanisms, including templating mechanisms, for converting or formatting stored Content 14 into forms and formats suitable to or desired by various Content Clients 26.

1. Dynamic Server 20D (FIG. 4)

First considering a Dynamic Content Delivery System 20D, as described Dynamic Content Delivery Systems 20D are optimized for the general distribution of Content 14 to Content Clients 26 and include the mechanisms and functions to format, display and distribute Content 14 received from Repository 38 or Cache 40 through Data Access Interface 48 into the forms and formats desired by Content Clients 26 on, for example, Web and wireless networks and on other platforms.

As discussed previously, both Content Sources 24 and Content Clients 26 may define the form and format of Content 14, with Content Sources 24 defining the form and format in which Content 14 is provided to the Content Acquisition System 18 and Content Clients 26, users or a system administrator, for example, defining the form and format in which Content 14 is delivered to Content Clients 26. For example, one Content Client 26 may request XML-formatted Content 14 for ease of integration with other Web based Content 14 while others of Content Clients 26 may request pre-formatted HTML or WML Content 14 for direct placement on a Web or wireless site.

In this regard, it has been described that Content 14 acquired through the Content Acquisition System 18 is parsed, deconstructed, identified and tagged with Tags 34T before being stored in the Repository 38. As described, each Tag 34T is comprised, for example, of identifying information, such as source, content type, form or format, content client, subject matter, and so on, or links or pointers to, for example, related Content 14 or Content 14 elements or Content Clients 26. Tags 34T and distribution Tags 38D thereby provide information and a structure by which Content 14 or elements of Content 14 may be queried, identified, reassembled and reformatted into any desired association or relationship, form and format for delivery to a Content Client 26. For example, when Content 14 or Content 14 elements are provided to the Content Distribution System 20 in response to a Request 44R, the associated Tag 34D or Tags 34D identifies, for example, the Request 44R, the requester or requesting Query Process 44QP, the requested form and format for the Content 14 and other parameters necessary for Content Distribution System 20 to form, format and deliver the requested Content 14 or Content 14 elements as required by the requester. In addition, it should be noted that, as previously described, the Content 14 provided to a Content Distribution System 20 from a Repository System 16 is in, for example, a conventional, standard database format or other known format or in a known format from a known and limited range of formats and is thereby easily reformatted or reformed into other forms or formats.

As illustrated in FIG. 4, a Dynamic Server 20D includes a Formatting Mechanism 52 and a Distribution Mechanism 54 for forming and formatting Content 14 or Content 14 elements received from a Repository System 16 into the forms and formats identified or required for distribution to the recipient, and delivery of the formatted Content 14. A Formatting Mechanism 52 will include Formatters 52F and Templating Engines 52T to support and provide formatting services for and corresponding to each type of content distribution format, method or system to be supported by the Content Distribution System 20. Formatters 52F may include services for, for example, Web, wireless, email, WML/WAP, cHTML, e-book and Palm Clipping systems, proprietary systems such as AvantGo and custom systems, methods and formats. Templating Engines 52T interoperate with Formatters 52F to format and form the Content 14 according to the desired forms and delivery systems and include associated Templates 52TT for, for example, Web, wireless/WAP, media stream, desktop, file JSP, JHTML and custom delivery systems.

A Formatting Mechanism 52 may also include Shortcut Mechanisms 52S supporting access and formatting “shortcuts” for, for example, wireless, mobile, and voice systems, support for WML, cHTML for iMode phones, and VoiceXML, and HTML subsets for handheld computers, set-top boxes, and electronic books. Shortcut Mechanisms 52S include automatic page splitters and content encoders for different devices, special caches, and gateway and protocol connectors and other device or platform specific markup languages.

A Formatting Mechanism 52 may also include Visualization Engines 52V supporting services and functions for creating custom data visualizations, such as two- and three-dimensional bar charts, line graphs, and other graphical data representations based on Content 14 and Content 14 elements retrieved from Repository 38 or Cache 40. Such custom visualizations are, in turn, included in or provided as Content 14 delivered to Content Clients 26, including users, user applications and systems and system administrators.

A Formatting Mechanism 52 may also include Envelope Engines 52E for compressing and encrypting Content 14, or otherwise transforming the Content 14 output. Envelope Engines 52E may also be used by, for example, Security Manager 46, to support secure storage and communications operation. Envelope transformers can be used to digest content; specifically to take multiple documents and create a single document digest useful for distributing large numbers of documents.

Lastly, Distribution Mechanism 54 is comprised of drivers and other systems, sub-systems and devices for the actual delivery of Content 14 to Content Clients 26, including users, user applications and systems and system administrators. Distribution Mechanism 54 will include, for example, drivers and protocols for serving wireless networks, Networks 16, including the Web, email, ebook and custom delivery methods and systems.

2. Content Syndication Systems 20S (FIG. 4)

As described above, Content Syndication Systems 20S are optimized for Content 14 redistribution among partnered or otherwise associated, related or cooperating Content Sources 24 and Content Clients 26, hereafter referred to as “syndicated” Content Sources 24 and Content Clients 26.

Syndication is a relationship between Content Sources 24 and Content Clients 26 for the controlled distribution or redistribution of Content 14. For example, online publishers, financial information providers, retailers, catalog producers, and other Content 14 originators may enter into Content 14 redistribution relationships among themselves to distribute Content 14 among themselves or to Content Clients 26 selected according to a variety of criteria, such as potential customers for goods or services. Some enterprises may operate according to a “channels-only” model, providing Content 14 distribution services for Content Sources 24. It will be apparent from the above descriptions of the mechanisms, functions and operations of a Content Exchange System 12 that a Content Exchange System 12 may function to support a full range of syndication services, including the acquisition or acceptance of Content 14 from Content Sources 14, the storing and aggregation of Content 14, and the formatting and distribution of Content 14 as specified by either or both of the Content Sources 24 and Content Clients 26. All or any of these processes may be performed under the specific and complete control of syndication partners, and in a manner specified by syndication partners. For example, a Content 14 redistribution relationship may be structured through a Content Exchange System 12 to forward formatted reports and documents to applications for bulk e-mail, archival storage, and other internal processes and may be delivered dynamically in real time, directly from a Content Repository 38R, or according to a programmed or scheduled delivery process. Each content redistribution transaction may be recorded and tracked and reproduced, for example, by an Event Mechanism 50F. Syndication processes may also incorporate other Content Exchange System 12 mechanisms and processes to, for example, query and extract Content 14 or Content 14 elements from Repository 38 or Cache 40 to be included in syndicated material, compress and encrypting the syndicated Content 14 output, and deliver the syndicated Content 14 through a range of systems and methods

Content syndication may also include “push and pull” syndication wherein Push syndication is initiated by the syndication server/system, and sends content to the client. Pull syndication is initiated by the client. The same content and processes are used for each.

The present system also supports ICE protocol (information and content exchange) wherein ICE is a messaging protocol for syndication that specifies the content and any instructions for deploying/processing that content on the receiving side.

It should also be noted that the present system further provides a syndication client system, which is an application that resides in the receiver's environment. A syndication client system receives ICE syndication messages, processes and transforms content, and stores it in a local repository. In fact, the client system the comprises a lightweight version of the Content Acquisition System.

A Content Syndication System 20S may be generally similar to a Distribution Server 20D, and may incorporate the same or similar elements and mechanisms as a Distribution Server 20D, such as Formatting Mechanism 52 with Formatters 52F, Templating Engines 52T and Templates 52TT, Visualization Engines 52V, Envelope Engines 52E and Distribution Mechanisms 54. As such, the descriptions of these elements and mechanisms will not be repeated here and reference may be made to the above description of a Distribution Server 20D, and the following will focus on functions and processes particular to a Content Syndication System 20D and syndication processes.

For example, a Content Syndication System 20D may include both passive and active syndication. In this regard, passive syndication is request-based, wherein syndicated Content 14 is delivered to a Content Client 26 upon request by the Content Client 26. Active syndication is “push” based and syndicated Content 14 is delivered to a Content Client 26 with request by the Content Client 24, such as according to a scheduled Query Process 44QP, at the direction of a Content Source 24 or upon identification of a Network 16 connection to Content Client 26 of a specified type, such as a user identified as a potential customer for goods or services.

A Content Exchange System 12 may also include Content 14 acquisition and storage mechanisms specifically for syndication relationships, but similar to those described herein above. For example, syndicated Content 14 may be acquired through a dedicated Retrieval Engine 32 or dedicated Retrieval Agent 32A and dedicated Retrieval Process 32P, stored in a dedicated Content Repository 38R, or distributed through a dedicated Content Syndication System 20S. A Content Exchange System 12 may incorporate a syndicated Content 14 storage facility, such as a file or network server or database, or may employ one or more Content Acquisition Systems 18 to manage multiple internal or external Content Sources 24.

The Content Exchange System 12 formatting mechanism described herein above may also be employed for hosted syndication, wherein Content 14 and the Content Exchange System 12 are rendered to appear as a syndication partner's Web site, wireless service, or other content offering. This method allows, for example, a syndication partner, such as a “distribution channel” enterprise, to enter into a redistribution relationship with a partner who, for technical or business reasons, is unable or does not desire to host the content themselves.

Lastly, it will be recognized that monitoring the “uptake” of syndicated Content 14, that is, the use of Content 14 by others, is necessary for billing, financial analysis, provisioning, or other business needs. A Content Syndication System 20S may include a Redistribution Monitor 56 responsive to the operation of a Distribution Mechanism 54 to capture and store content redistribution records for measuring partner activity, and such monitoring may also be achieved through Event Mechanism 50F. In other implementations, a Remote Tracking Agent 58 resident in a Content Source 24 may monitor end-user access to syndicated Content 14 through monitoring tags embedded into the syndicated Content 14 by, for example, a Formatter 52F. In this instance, a monitoring tag will transmit an access indication through the Content Syndication System 20S and to a Remote Tracking Agent 58 resident in the Content Source 24 each time the syndicated Content 14 is accessed by an end user. The access indicated transmitted from the monitoring tag may include, for example, information about the Content 14 that is accessed and information regarding the syndication partner.

It will be recognized from the above descriptions that there are many similarities between content acquisition and distribution, as reflected in the architecture and general processes described herein. For example, a significant elements of the system is the recognition of this similarity, and the use of it to build a more powerful, integrated system than could previously be created. Specifically, when connecting to a content repository source for distribution, that operation is identical to, and fully interchangeable with, connecting to a remote source for acquisition. When storing content in a repository after it has been retrieved via acquisition, that is identical to, and fully interchangeable with, connecting to a destination and delivering the content for distribution. The functionality of the system is thereby grouped into “tasks”, of which the most significant are: “Retrieve” which pulls content from sources/repositories, “Parse” which deconstructs content into elements, “Transform” which reassembles content elements into documents and manipulates those documents, and “Store” which delivers content to a repository/destination. Acquisition is “Retrieve (from remote source) →Parse→Store (in local repository)”; Distribution is “Retrieve (from local repository) →Transform →Store (in remote destination).

In conclusion, while the invention has been particularly shown and described with reference to preferred embodiments of the apparatus and methods thereof, it will be also understood by those of ordinary skill in the art that various changes, variations and modifications in form, details and implementation may be made therein without departing from the spirit and scope of the invention as defined by the appended claims. For example, the adaptation of the method and apparatus of the present invention to various widely divergent types of phase array transmitting and receiving systems will be readily apparent to those of ordinary skill in the relevant arts. Therefore, it is the object of the appended claims to cover all such variation and modifications of the invention as come within the true spirit and scope of the invention.

What is claimed is:

1. A content exchange system for the dynamic acquisition, management and distribution of content through a network and to content clients, comprising:
an content acquisition system communicating with a content source for receiving content from the content source and parsing and formatting the content for storage and for distribution to the content clients,
a repository system for storing and managing the content and content relationships and for retrieving the content for distribution to the content clients, and
a content distribution system for receiving the content from the repository system and formatting and distributing the content to the content clients.

2. The content exchange system of claim 1, wherein an content acquisition system comprises:
a retrieval engine for acquiring content from the content source, including one or more of actively fetching content from the content source and passively accepting content from the content source, and
a content processor, including
a content parser for parsing the content into content items wherein each content item is an identifiable body of content,
a content formatter for formatting the content into formats and relationships identified by the content clients, and
a tag mechanism for associating a tag with each content item wherein each tag contains identification information pertaining to the corresponding content item.

3. The content exchange system of claim 1, wherein the content processor and tag mechanism further associate content items in accordance with aggregation relationships defined by identification information residing in the corresponding tags.

4. The content exchange system of claim 2, wherein a retrieval engine comprises:
a retrieval agent for communicating with a content source and acquiring content from the content source, including one or more of actively fetching content from the content source and passively accepting content from the content source, and
a retrieval process defined by one or more content clients for controlling a corresponding retrieval agent.

5. The content exchange system of claim 1, wherein the repository system comprises:
a repository for storing the content,
a repository manager for controlling the storage of data in the repository,
at least one repository connector providing a defined access path to the repository, and
a query engine for receiving requests for content from content clients and generating corresponding queries to the repository for the requested content,
the repository manager being responsive to a query for providing the requested content to the requesting content client.

6. The content exchange system of claim 5, wherein the repository system further comprises:
a cache connected from the repository for storing and providing the content to content clients.

7. The content exchange system of claim 5, wherein the repository further includes at least repository template associated with the at least one repository connector for formatting content to be stored in or read from the repository.

8. The content exchange system of claim 5, wherein the repository further includes a data persistence manager associated with the repository manager for managing the duration of storage of content items in the repository.

9. The content exchange system of claim 5, wherein the query engine further includes:
a request parser for parsing and deconstructing requests to identify the content items and requirements of each request for content, and
at least one query template for formulating a query corresponding to the content items and requirements identified from a content request.

10. The content exchange system of claim 1, wherein the content distribution system includes:
one or more of a dynamic server optimized for the general distribution of content to content clients, and
a syndication server for distribution of content to associated content clients.

11. The content exchange system of claim 1, wherein the content distribution system includes:
a distribution mechanism for distribution of content to content clients, and
a formatting mechanism for formatting content into formats defined by the content clients, a formatting mechanism including
a formatter for receiving content from the repository system and formatting the content for distribution to a content client, including
a template engine for formatting content, and
at least one template for defining a format for content.

12. A method for the dynamic acquisition, management and distribution of content through a network and to content clients, comprising the steps of:
communicating with a content source for receiving content from the content source and parsing and formatting the content for storage and for distribution to the content clients,
storing and managing the content and content relationships and retrieving the content for distribution to the content clients, and
receiving the content from the repository system and formatting and distributing the content to the content clients.

13. The method of claim 12, further including the steps of:
acquiring content from the content source, including one or more of actively fetching content from the content source and passively accepting content from the content source, and
parsing the content into content items wherein each content item is an identifiable body of content,
formatting the content into formats and relationships identified by the content clients, and
associating a tag with each content item wherein each tag contains identification information pertaining to the corresponding content item.

14. The method of claim 12, further comprising the step of associating content items in accordance with aggregation relationships defined by identification information residing in the corresponding tags.

15. The method of claim 13, further including the step of using a retrieval process defined by one or more content clients to control communicating with a content source and acquiring content from the content source, including one or more of actively fetching content from the content source and passively accepting content from the content source.

16. The method of claim 12, further including the steps of:
storing the content in a repository,
controlling the storage of data in the repository by means of a repository manager,
accessing the repository by means of a repository connector providing a defined access path to the repository, and
retrieving content from the repository in response to queries generated in response to requests from content clients for content.

17. The method of claim 16, further including: wherein the repository system further comprises:
storing the content in a cache connected from the repository and providing the content to content clients from the cache.

18. The method of claim 16, further comprising the step of formatting the content to be stored in the repository by means of at least repository template associated with the at least one repository connector.

19. The method of claim 16, further comprising the step of controlling the persistence of content storage in the repository.

20. The method of claim 16, further comprising the steps of generating a query by:
parsing and deconstructing requests to identify the content items and requirements of each request for content, and
formulating a query corresponding to the content items and requirements identified from a content request according to at least one corresponding query template.

21. The method of claim 12, further comprising the steps of distributing content to content clients by one of more of dynamic general distribution of content to content clients, and syndicated distribution of content to associated content clients.

22. The method of claim 12, wherein the steps of distribution content to content clients further include the steps of:
formatting content into formats defined by the content clients according to at least one content distribution template defined for at least one corresponding content client.
